(19) United States
(12) Patent Application Publication
(10) Pub. No.: US 2008/0147909 A1
(43) Pub. Date: Jun. 19, 2008

(54) Remote USB protocol for a heterogeneous system

(76) Inventors: Winters Zhang, Shanghai (CN); Hongbing Zhang, Shanghai (CN); Thomas Wang, Shanghai (CN); Minqiang Wu, Shanghai (CN)

Correspondence Address: INTEL/BLAKELY, 1279 OAKMEAD PARKWAY, SUNNYVALE, CA, 94085-4040, US

(21) Appl. No.: 11/641,423

(22) Filed: Dec. 18, 2006

(51) Int. Cl. G06F 13/28; G06F 13/20; G06F 13/00

(52) U.S. Cl. 710/24; 710/313; 710/301

(57) ABSTRACT

Machine-readable media, methods, apparatus and system are described. In some embodiments, a host platform may receive a first USB command from a client platform, wherein the first USB command notifies the host platform that a USB device is plugged into the client platform. The host platform may further create a virtual USB device as a virtualization of the USB device in response to the first USB command, and may establish a USB device driver in response to the creation of the virtual USB device. The USB device driver may control the USB device in the client platform.

### BACKGROUND

Conventionally, a heterogeneous system may comprise a host platform and a client platform connected with each other. The host platform and the client platform may respectively run different operating systems: a host operating system and a client operating system. A universal serial bus (USB) device may be coupled to the host platform or the client platform to implement input/output (I/O) operations with support from a local USB device driver loaded by the host operating system or the client operating system.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a system comprising a host platform and a client platform.

FIG. 2 illustrates an embodiment of a method of plugging a USB device into the client platform.

FIG. 3 illustrates an embodiment of a method of loading a USB device driver associated with the USB device.

FIG. 4 illustrates an embodiment of a method of sending a USB I/O request from the host platform to the client platform.

FIG. 5 illustrates an embodiment of a method of sending a response to the remote USB I/O request from the client platform to the host platform.

FIG. 6 illustrates an embodiment of a remote USB data format.

FIG. 7 illustrates an embodiment of a general computing platform implemented as the host platform or the client platform.

### DETAILED DESCRIPTION

The following description describes techniques for a remote USB protocol for a heterogeneous system. In the following description, numerous specific details such as logic implementations, pseudo-code, methods to specify operands, resource partitioning/sharing/duplication implementations, types and interrelationships of system components, and logic partitioning/integration choices are set forth in order to provide a more thorough understanding of the current invention. However, the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium that may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.) and others.

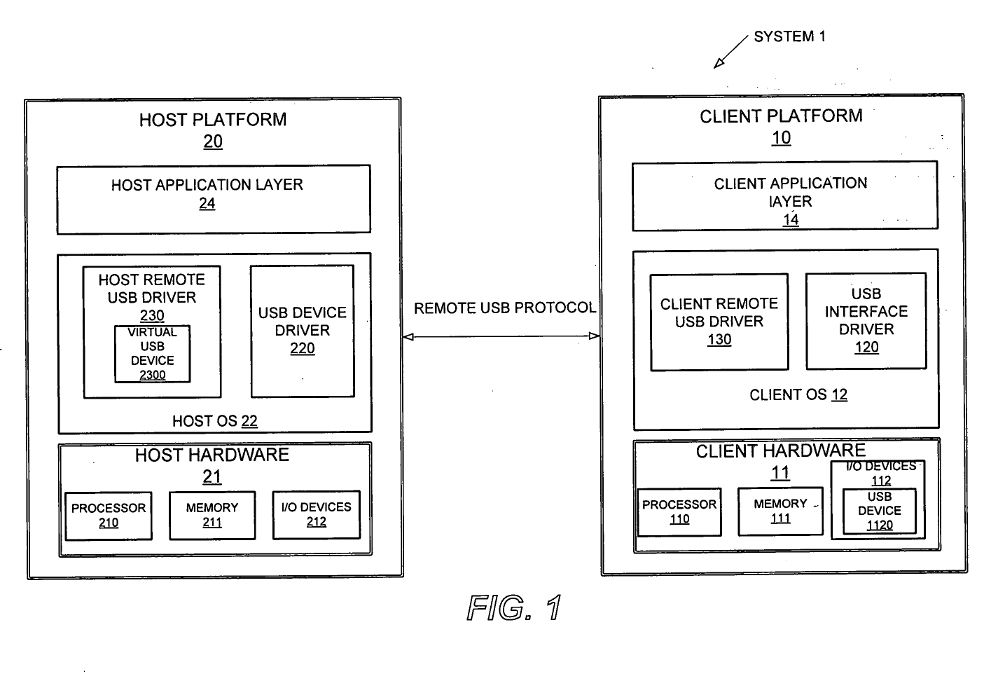

FIG. 1 shows an embodiment of a system 1. System 1 may comprise a client platform 10 and a host platform 20 with a wired or wireless connection to each other.

Client platform 10 may comprise client hardware 11, a client operating system (OS) 12, and a client application layer 14. Examples of client platform 10 may comprise a content processing device coupled to a play-back unit (e.g., a set-top box coupled to a television) that may receive content from host platform 20, play back the content to the user of client platform 10 and transmit inputs from the user to host platform 20.

The client hardware 11 may comprise one or more processors 110, a memory 111 and I/O devices 112. I/O devices 112 may comprise a USB device 1120 which may perform I/O operation under a certain USB specification, e.g., USB specification revision 2.0. USB device 1120 may connect with an USB interface controller (not shown) of client platform 10, which may further interconnect with other components of client platform 10 through a USB bus (not shown).

Client OS 12 may run over client hardware 11 to control every task that client platform 10 carries out and to manage system resources to optimize performance. Examples of client OS 12 may comprise Linux, Windows, FreeBSD Unix, etc. Client OS 12 may comprise a USB interface driver 120 to interface between USB device 1120 and a client remote USB driver 130 residing in client OS 12. For example, USB interface driver 120 may control USB device 1120 to perform a configuration or I/O operation based upon a client USB command (in) from client remote USB driver 130. USB interface driver 120 may further generate a client USB command (out) in response to the configuration or I/O operation of USB device 1120.

The structure of USB interface driver 120 may vary based upon the architecture of client OS 12. For example, if client OS 12 complies with the Linux architecture, USB interface driver 120 may comprise a PCI device driver, a USB OHCI driver and a USB core (not shown). In light of this, the client USB commands used by USB interface driver 120 may comply with the client OS architecture.

Client OS 12 may further comprise a client remote USB driver 130, which may be responsible for translating the client USB command from USB interface driver 120 that complies with the client OS architecture into a remote USB command to be transmitted to host platform 20 based upon a certain transmission protocol, e.g., transfer control protocol (TCP). The remote USB command may adopt a remote USB format that complies with a remote USB protocol. The remote USB protocol is described herein. More details of the remote USB protocol will be discussed later.

Client remote USB driver 130 may be further responsible for translating a remote USB command received from host platform 20 that complies with the remote USB protocol into the client USB command that complies with the client OS architecture.

Client application layer 14 may be a software application running in client platform 10. Client application layer 14 may further control the transceiving of the remote USB commands between client platform 10 and host platform 20 that may be performed by I/O devices 112 (e.g., a network card).

Host platform 20 may comprise host hardware 21, a host OS 22, and a host application layer 24. Host platform 20 may provide a user interface to the client platform 10 to provide content to be displayed at client platform 10 and handle user inputs received from client platform 10. Examples for host platform 20 may comprise a mainframe computer, mini-computer, personal computer, portable computer, laptop computer and other devices for transceiving and processing data.

Host hardware 21 may comprise one or more processors 210, a memory 211 and I/O devices 212.

Host OS 22 may run over client hardware 11 to control every task that host platform 20 carries out and to manage system resources to optimize performance. Examples of host OS 12 may comprise Windows, Linux, FreeBSD Unix, etc. In the embodiment of FIG. 1, host OS 22 may be different from client OS 12. For example, host OS 22 may adopt a Windows architecture, while client OS 12 may adopt a Linux architecture. However, both of host OS 22 and client OS 12 may comply with the same USB specification, e.g., the USB specification revision 2.0.

Host OS 22 may further comprise a host remote USB driver 230. Host remote USB driver 230 may create a virtual USB device 2300 that may be a virtualization of USB device 1120, so as to trigger host OS 22 to load a USB device driver 220 to service USB device 1120. Host remote USB driver 230 may further translate the host USB command that may comply with the host OS architecture into a remote USB command in a remote format that may comply with the remote protocol. The remote USB command may be further transmitted to client platform 10. Host remote USB driver 230 may further translate a remote USB command received from client platform 10 that may comply with the remote protocol into a host USB command that may comply with the host OS architecture.

Host OS 22 may further comprise USB device driver 220 associated with USB device 1120 inserted in client platform 10. USB device driver 220 may bridge host application layer 24 that may use USB device 1120 for I/O operation with host remote USB driver 230 that may translate between the host USB command and the remote USB command. For example, USB device driver 220 may generate a host USB command to configure the USB device 1120 or request the USB device 1120 to input or output data based upon host application layer 20. USB device driver 220 may further report a USB configuration or USB I/O data to host application layer 24 based upon a host USB command received from host remote USB driver 230. Since USB device driver 220 is loaded by host OS 22, the host USB command used by USB device driver 220 may comply with the host OS architecture.

Host application layer 24 may be a software application that may provide the user interface to the user of client platform 10. For example, the host application layer 24 may provide content to client platform 10 to be played back for the user of client platform 10 and handle the user inputs received from client platform 10. Host application layer 24 may further control the transceiving of the remote USB commands between client platform 10 and host platform 20 that may be performed by I/O devices 212 (e.g., a network card).

Other technologies may implement other embodiments of the structure of system 1. For example, host platform 20 may connect with a number of the client platforms and provide USB device drivers for the USB devices in different client platforms. For another example, the remote USB commands are transceived on a driver level, but not on the application level.

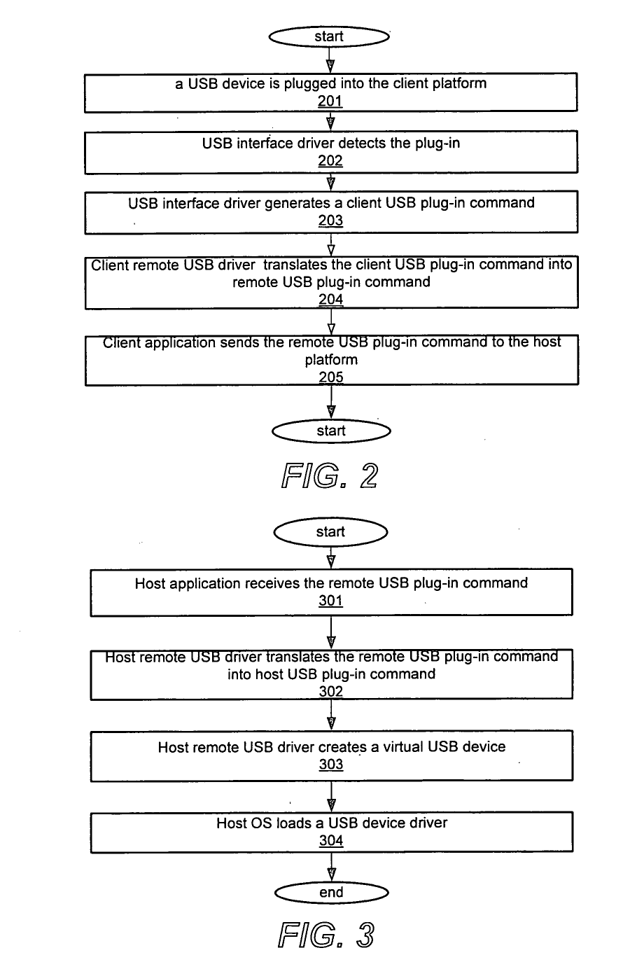

FIG. 2 illustrates an embodiment of a method of plugging a USB device into client platform 10.

In block 201, USB device 1120 is plugged into client platform 10. For example, USB device 1120 is plugged into the USB interface (not shown) of client platform 10. In block 202, USB interface driver 120 may detect the plug-in operation, and then, may generate a client USB plug-in command complying with the client OS architecture. The client USB plug-in command may be used to notify host platform 20 that USB device 1120 has been plugged into client platform 10.

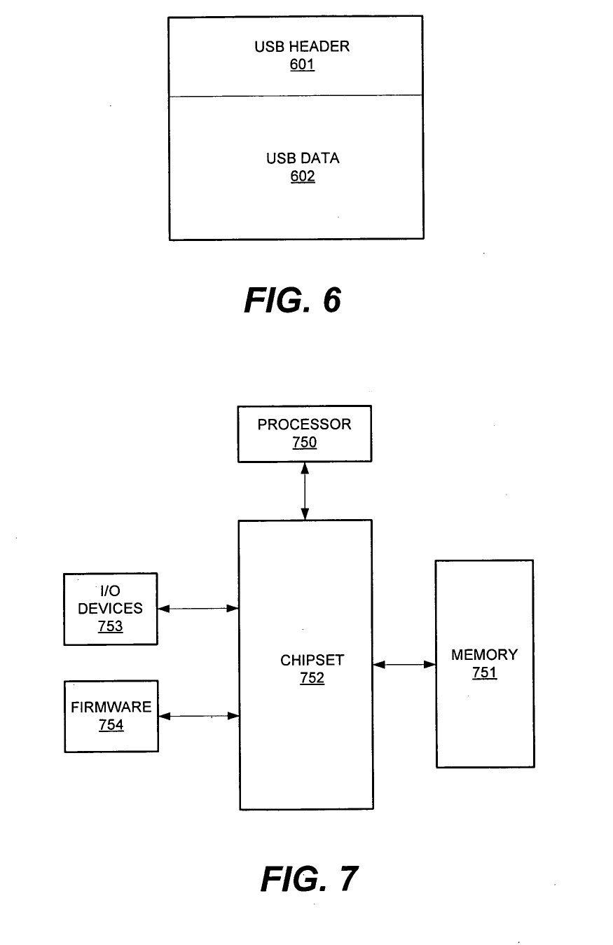

In block 204, client remote USB driver 130 may translate the client USB plug-in command into a remote USB plug-in command in the remote USB data format complying with the remote USB protocol. FIG. 6 depicts an embodiment of the remote USB data format. As depicted, the remote USB data format may comprise a remote USB header field 601 and a remote USB data field 602. Remote USB header field 601 may comprise various information, such as a remote USB command length, remote USB command codes and a remote USB status. The remote USB command length may record the length of the whole remote USB command. The remote USB command codes may comprise command codes of the remote USB command. The remote USB status may record status of the remote USB command, such as completed or pending. Remote USB data field 602 may record data members of the remote USB command. Count and type of the data member may vary with different remote USB command codes.

Referring back to FIG. 2, various technologies may be applied for block 204. In an embodiment, client remote USB driver 130 may extract information from the client USB plug-in command that may comply with the USB specification adopted by both client platform 10 and host platform 20, while discarding other information that may be required due to the characterizations of the client OS. For example, the extracted information may comprise USB command codes specified by the USB specification, such as a control transfer command, interrupt transfer command, bulk transfer command, and isochronous transfer command specified by the USB specification revision 2.0. Then, client remote USB driver 130 may generate the remote USB command by restructuring the extracted information in the remote USB data format specified by the remote USB protocol.

In block 205, client application layer 14 may send the remote USB plug-in command from client platform 10 to host platform 20 according to a certain transfer protocol, such as the TCP protocol.

FIG. 3 illustrates an embodiment of a method of loading a USB device driver 220 associated with USB device 1120.

In block 301, host application layer 24 may receive the remote USB plug-in command from client platform 10. In block 302, host remote USB driver 230 may translate the remote USB plug-in command that complies with the remote USB protocol into a host USB plug-in command that complies with the host OS architecture. Various technologies may be applied for block 302. In an embodiment, host remote USB driver 230 may extract information from the remote USB plug-in command. The extracted information may comply with the USB specification adopted by both of client platform 10 and host platform 20. For example, the extracted information may comprise USB command codes specified by the USB specification, such as a control transfer command, interrupt transfer command, bulk transfer command, and isochronous transfer command specified by the USB specification revision 2.0.

Then, host remote USB driver 230 may generate the host USB plug-in command based upon the extracted information. For example, host remote USB driver 230 may combine the extracted information with other information required by the host OS architecture so as to obtain the host USB command that complies with the host OS architecture.

In block 303, the host remote USB driver 230 may create virtual USB device 2300 which may be a virtualization of USB device 1120. In response to creating virtual USB device 2300, host OS 22 may load USB device driver 220 to service USB device 1120 in block 304, such as configuring USB device 1120 and requesting USB device 1120 to input/output data based upon the host application layer 24 that use the USB device 1120.

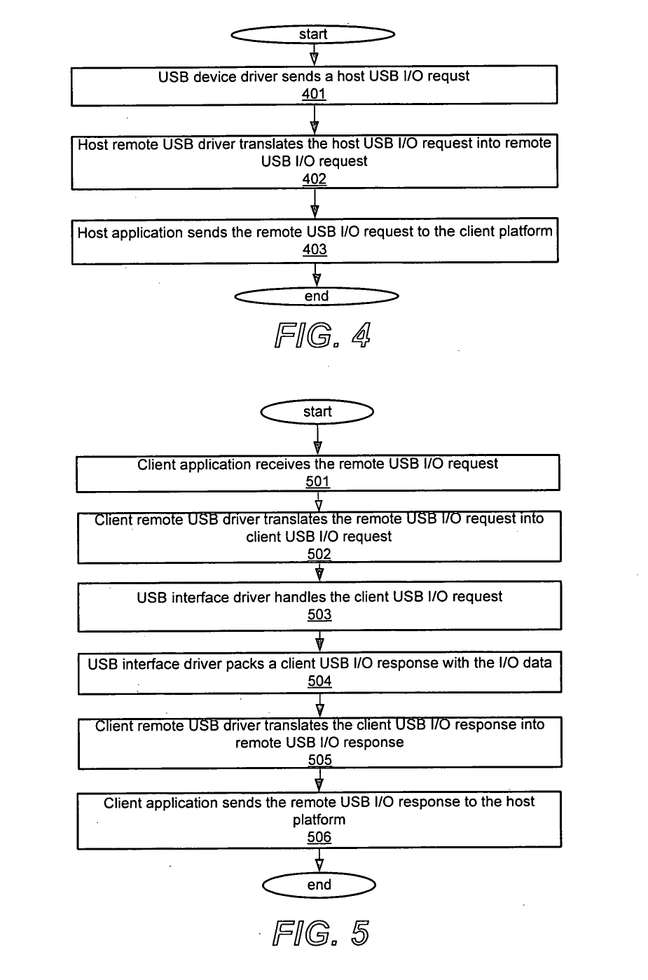

FIG. 4 illustrates an embodiment of a method of sending a USB I/O request from host platform 20 to client platform 10.

In block 401, USB device driver 220 may generate a host USB I/O request to request USB device 1120 to input/output data to host application layer 24. The host USB I/O request may comply with the host OS architecture. In block 402, host remote USB driver 230 may translate the host USB I/O request into a remote USB I/O request. In an embodiment, host remote USB driver 230 may extract information from the host USB I/O request that complies with the USB specification adopted by both of the host platform 20 and the client platform 10, while discarding other information required by the host OS architecture.

Then, host remote USB driver 230 may generate the remote USB I/O request by restructuring the extracted information in the remote USB data format specified by the remote USB protocol.

In block 403, host application layer 24 may transmit the remote USB I/O request to client platform 10 based upon a certain transfer protocol.

FIG. 5 illustrates an embodiment of a method of sending a response to the remote USB I/O request from client platform 10 to host platform 20.

In block 501, client application layer 14 may receive the remote USB I/O request from host platform 20. In block 502, client remote USB driver 130 may translate the remote USB I/O request into a client USB I/O request. In an embodiment, client remote USB driver 130 may extract information from the remote USB I/O request that complies with the USB specification adopted by both of client platform 10 and host platform 20. Then, client remote USB driver 130 may generate the client USB I/O request by combining the extracted information with other information required by the client OS architecture.

In block 503, USB interface driver 120 may handle client USB I/O request. For example, USB interface driver 120 may instruct USB device 1120 to input the data for input request, or output the data to USB device 1120 for output request. Then, in block 504, USB interface driver 120 may pack a client USB I/O response upon completion of the input/output operation by USB device 1120. For input operation, USB interface driver 120 may add the input data into the client USB I/O request to obtain the client USB I/O response. For output operation, USB interface driver 120 may add a request status, e.g., complete, into the client USB I/O request to obtain the client USB I/O response.

In block 505, client remote USB driver 130 may translate the client USB I/O response into a remote USB I/O response, for example, by extracting information from the client USB I/O response that complies with the USB specification and generating the remote USB I/O response by restructuring the extracted information in the remote USB data format specified by the remote USB protocol.

In block 506, client application layer 14 may send the remote USB I/O response to host platform 20.

At host platform 20 side, host remote USB driver 230 may translate the remote USB I/O response into a host USB I/O response complying with the host OS architecture and report the I/O response to host application layer 24.

FIG. 7 depicts an embodiment of a general computing platform that may act as a client platform 10 or host platform 20. The computing platform may comprise one or more processors 750, memory 751, chipset 752, I/O device 753, and firmware 754. Processors 750 are communicatively coupled to the other components via one or more buses such as a processor bus. Processors 750 may be implemented as an integrated circuit (IC) with one or more processing cores that may execute codes under a suitable architecture, for example, including Intel® Xeon™, Intel® Pentium™, Intel® Itanium™ architectures, available from Intel Corporation of Santa Clara, Calif.

In an embodiment, memory 751 may store codes to be executed by processors 750. A non-exhaustive list of examples for memory 751 may comprise one or a combination of the following semiconductor devices, such as synchronous dynamic random access memory (SDRAM) devices, RAMBUS dynamic random access memory (RDRAM) devices, double data rate (DDR) memory devices, static random access memory (SRAM), and flash memory devices.

In an embodiment, chipset 752 may provide one or more communicative path among processors 750, memory 751 and various components, such as I/O device 753 and firmware 754. Examples for I/O devices 753 may comprise a keyboard, mouse, network interface, a storage device, a camera, a blue-tooth, and an antenna.

Firmware 754 may store BIOS routines that the computing platform executes during system startup in order to initialize processors 750, chipset 752, and other components of the computing platform and/or EFI routines to interface firmware 754 with an operating system of the computing platform and provide a standard environment for booting the operating system.

While certain features of the invention have been described with reference to example embodiments, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A method of operating a client platform, comprising:
generating a first universal serial bus (USB) command complying with a client operating system of the client platform; and
extracting first information from the first USB command, wherein the first information complies with a USB specification adopted by the client platform and a host platform, and wherein the host platform runs a host operating system different from the client operating system; and
generating a second USB command complying with a remote USB protocol, wherein the second USB command includes the extracted first information.

2. The method of claim 1, further comprising:
transmitting the second USB command to the host platform.

3. The method of claim 1, wherein generating the first USB command comprises:
detecting that a USB device is plugged into the client platform;
constructing the first USB command complying with the client operating system, wherein the first USB command triggers the host platform to establish a USB device driver to control the USB device.

4. The method of claim 1, further comprising:
receiving a third USB command complying with the remote USB protocol from the host platform; and
extracting second information from the third USB command, wherein the second information complies with the USB specification adopted by the client platform and the host platform; and
generating a fourth USB command complying with the client operating system, wherein the fourth USB command includes the extracted second information.

5. The method of claim 4, further comprising:
controlling a USB device of the client platform to perform at least one of a configuration operation, an input operation and an output operation instructed by the fourth USB command.

6. A method of operating a host platform, comprising:
receiving a first USB command from a client platform, wherein the first USB command notifies the host platform that a USB device is plugged into the client platform;
creating a virtual USB device as a virtualization of the USB device in response to the first USB command; and
establishing a USB device driver in response to the creation of the virtual USB device, wherein the USB device driver controls the USB device in the client platform.

7. The method of claim 6, wherein a host operating system running in the host platform is different from a client operation system running in the client platform, and wherein the first USB command complies with a remote USB protocol.

8. The method of claim 7, further comprising:
extracting a first information from the first USB command, wherein the first information complies with a USB specification adopted by the host platform and the client platform; and
generating a second USB command complying with the host operating system, wherein the second USB command includes the extracted first information.

9. The method of claim 6, further comprising:
generating a third USB command by the USB device driver to control at least one of a configuration operation, an input operation and an output operation of the USB device in the client platform; and
transmitting the third USB command to the client platform.

10. The method of claim 9, wherein the third USB command complies with a host operating system of the host platform, and wherein the host operating system is different from a client operating system of the client platform.

11. The method of claim 10, further comprising:
extracting second information from the third USB command, wherein the second information complies with a USB specification adopted by the host platform and the client platform; and
generating a fourth USB command complying with a remote USB protocol, wherein the fourth USB command includes the extracted second information.

12. A host platform, comprising:
an input/output device to receive a first USB command from a client platform, wherein the first USB command notifies the host platform that a USB device is plugged into the client platform;
a virtual USB device, created as a virtualization of the USB device in response to the first USB command; and
a USB device driver, established in response to the creation of the virtual USB device, to control the USB device in the client platform.

13. The host platform of claim 12, wherein a host operating system running in the host platform is different from a client operating system running in the client platform, and wherein the first USB commands complies with a remote USB protocol.

14. The host platform of claim 13, further comprising a host USB remote driver to:
extract a first information from the first USB command, wherein the first information complies with a USB specification adopted by the host platform and the client platform; and
generate a second USB command complying with the host operating system, wherein the second USB command includes the extracted first information.

15. The host platform of claim 12, wherein the USB device driver further generates a third USB command to control at least one of a configuration operation, an input operation and an output operation of the USB device in the client platform; and the input/output device further transmits the third USB command to the client platform.

16. The host platform of claim 15, wherein the third USB command complies with a host operating system of the host platform, and wherein the host operating system is different from a client operating system of the client platform.

17. The host platform of claim 16, further comprising a host remote USB driver to:
extract second information from the third USB command, wherein the second information complies with a USB specification adopted by the host platform and the client platform; and
generating a fourth USB command complying with a remote USB protocol, wherein the fourth USB command includes the extracted second information.

18. A machine-readable medium comprising a plurality of instructions which when executed result in a host platform:
receiving a first USB command from a client platform, wherein the first USB command notifies the host platform that a USB device is plugged into the client platform;
creating a virtual USB device as a virtualization of the USB device in response to the first USB command; and
establishing a USB device driver in response to the creation of the virtual USB device, wherein the USB device driver controls the USB device in the client platform.

19. The machine-readable medium of claim 18, wherein a host operating system running in the host platform is different from a client operation system running in the client platform, and wherein the first USB commands complies with a remote USB protocol.

20. The machine readable medium of claim 19, wherein the plurality of instructions further result in the host platform:
extracting a first information from the first USB command, wherein the first information complies with a USB specification adopted by the host platform and the client platform; and
generating a second USB command complying with the host operating system, wherein the second USB command includes the extracted first information.

21. The machine readable medium of claim 18, wherein the plurality of instructions further result in the host platform:
generating a third USB command by the USB device driver to control at least one of a configuration operation, an input operation and an output operation of the USB device in the client platform; and
transmitting the third USB command to the client platform.

22. The machine readable medium of claim 21, wherein the third USB command complies with a host operating system of the host platform, and wherein the host operating system is different from a client operating system of the client platform.

23. The machine readable medium of claim 22, wherein the plurality of instructions further result in the host platform:
extracting second information from the third USB command, wherein the second information complies with a USB specification adopted by the host platform and the client platform; and
generating a fourth USB command complying with a remote USB protocol, wherein the fourth USB command includes the extracted second information.
